(19) United States
(12) Patent Application Publication
(10) Pub. No.: US 2016/0381204 A1
(43) Pub. Date: Dec. 29, 2016

(54) MOBILE MANAGEMENT FRAMEWORK

(71) Applicant: International Business Machines Corporation, Armonk, NY (US)

(72) Inventors: Swaminathan Chandrasekaran, Coppell, TX (US); Mathews Thomas, Flower Mound, TX (US); Janki Y. Vora, Dallas, TX (US); Julio Wong, Pembroke Pines, FL (US)

(21) Appl. No.: 14/748,770

(22) Filed: Jun. 24, 2015

(51) Int. Cl. H04M 1/725; G06F 9/44; G06F 3/0481; G06F 3/048; G06K 9/00

(52) U.S. Cl. CPC H04M 1/72569; H04M 1/72586; G06F 3/048; G06K 9/00288; G06F 3/04817; G06F 9/4443

(57) ABSTRACT

A method for adjusting aspects of an application in a user interface is provided. A user profile is received, wherein the user profile corresponds to a first user of a mobile device. Data corresponding to an application is received, wherein the application is compatible with the mobile device. An application is determined to be likely to be accessed by the first user based on the data corresponding to the application. At least one aspect of the application is adjusted on a user interface of the mobile device.

### BACKGROUND OF THE INVENTION

The present invention relates generally to the field of mobile application management, and more particularly to customizing application interfaces via mobile management framework.

Mobile applications are computer programs designed to run on smartphones, tablet computers, or other mobile devices. Mobile applications are generally available through application distribution platforms, operated by the owner of the mobile operating system. Availability of developer tools has proliferated the number of mobile applications available to the public. Mobile applications are available for a variety of tasks. Often, users have a choice among multiple applications that provide the same or similar functionality in performing specific tasks. For example, a user who needs a mobile application for text messaging has hundreds or thousands of application options available in the application distribution platforms. In some instances, users may not know that an application installed on their mobile device has the needed functionality.

### SUMMARY

According to one embodiment of the present disclosure, a method for adjusting application aspects in a user interface is provided. The method includes receiving, by one or more processors, a user profile, wherein the user profile corresponds to a first user of a mobile device; receiving, by or more processors, data corresponding to an application, wherein the application is compatible with the mobile device; determining, by one or more processors, that the application is likely to be accessed by the first user based on, at least, the data corresponding to the application; and adjusting, by one or more processors, at least one aspect of the application on a user interface of the mobile device.

According to another embodiment of the present disclosure, a computer program product for adjusting application aspects in a user interface is provided. The computer program product comprises a computer readable storage medium and program instructions stored on the computer readable storage medium. The program instructions include program instructions to program instructions to receive a user profile, wherein the user profile corresponds to a first user of a mobile device; program instructions to receive data corresponding to an application, wherein the application is compatible with the mobile device; program instructions to determine that the application is likely to be accessed by the first user based on, at least, the data corresponding to the application; and program instructions to adjust at least one aspect of the application on a user interface of the mobile device.

According to another embodiment of the present disclosure, a computer system for adjusting application aspects in a user interface is provided. The computer system includes one or more computer processors, one or more computer readable storage media, and program instructions stored on the computer readable storage media for execution by at least one of the one or more processors. The program instructions include program instructions to program instructions to receive a user profile, wherein the user profile corresponds to a first user of a mobile device; program instructions to receive data corresponding to an application, wherein the application is compatible with the mobile device; program instructions to determine that the application is likely to be accessed by the first user based on, at least, the data corresponding to the application; and program instructions to adjust at least one aspect of the application on a user interface of the mobile device.

### BRIEF DESCRIPTION OF THE DRAWINGS

FIG. 1 is a functional block diagram illustrating a computing environment, in accordance with an embodiment of the present disclosure;

FIG. 2 is a functional block diagram illustrating interactions of components, on a computing device within the computing environment of FIG. 1, in accordance with an embodiment of the present disclosure;

FIG. 3 is a flowchart depicting operations for managing application framework, on a computing device within the computing environment of FIG. 1, in accordance with an embodiment of the present disclosure; and

FIG. 4 is a block diagram of components of a computing device executing operations for managing application framework, in accordance with an embodiment of the present disclosure.

### DETAILED DESCRIPTION

An embodiment of the present invention recognizes that an immeasurable number of applications exist for use on mobile devices. The sheer number of applications leads to inefficient use of applications by mobile device users. For example, a user may have several applications on their mobile device with overlapping functionality. The overlapping functionality can be a waste of resources. In addition to the increasing number of applications, the sensitivity of information handled by applications is increasing. While mobile devices store sensitive information, users often allow others to use their mobile device. In these cases, some users may wish to keep the information hidden from children or other users of the mobile device.

An embodiment of the present invention provides a mobile management framework to manage the presentation of applications on a mobile device. In some embodiments, the mobile management framework modifies accessible applications based on the user of the mobile device. In other embodiments, the mobile management framework installs or deletes applications from the mobile device based, in part, on the functions provided by various applications. In still other embodiments, the mobile management framework queues applications based on the user's application usage history.

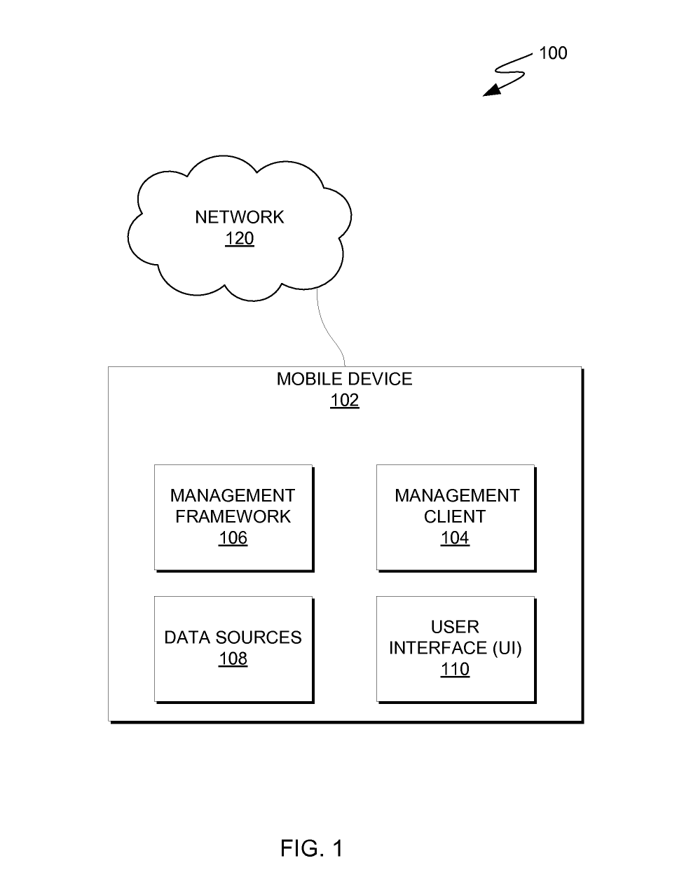

The present disclosure will now be described in detail with reference to the Figures. FIG. 1 is a functional block diagram illustrating a computing environment, in accordance with an embodiment of the present disclosure. For example, FIG. 1 is a functional block diagram illustrating computing environment 100. Computing environment 100 includes mobile device 102 connected over network 120. Mobile device 102 includes management client 104, management framework 106, data sources 108, and user interface (UI) 110.

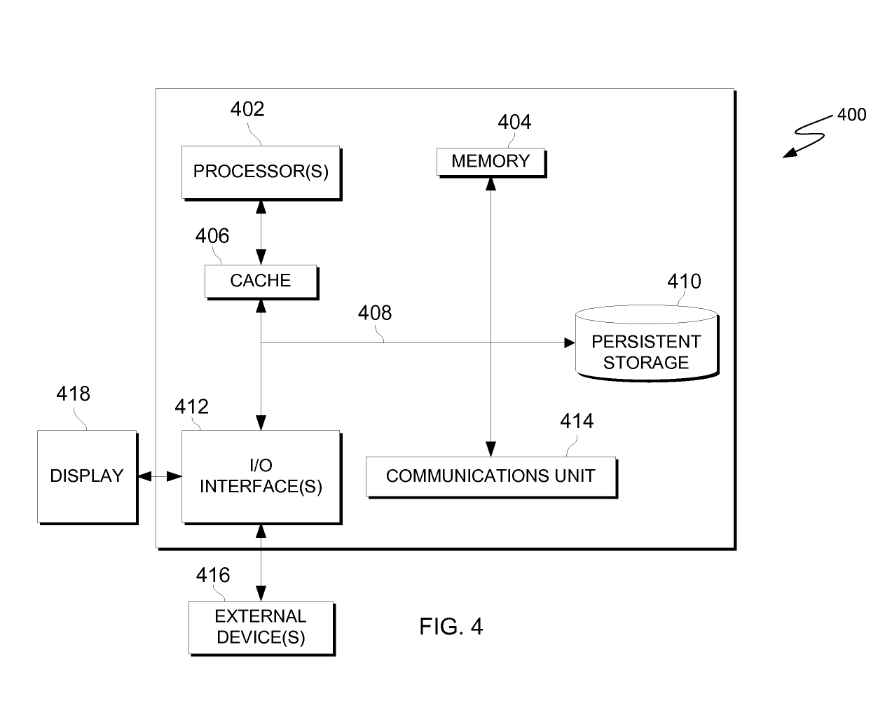

In various embodiments, mobile device 102 is a computing device that can be a laptop computer, a tablet computer, a netbook computer, a personal digital assistant (PDA), a smart phone, or any mobile programmable electronic device. In another embodiment, mobile device 102 represents a computing system utilizing clustered computers and components to act as a single pool of seamless resources. In general, mobile device 102 can be any computing device or a combination of devices with access to and/or capable of executing some or all of management client 104, management framework 106, and data sources 108. Mobile device 102 may include internal and external hardware components, as depicted and described in further detail with respect to FIG. 4.

In this exemplary embodiment, management client 104, management framework 106, and data sources 108 are stored on mobile device 102. In other embodiments, one or all of management client 104, management framework 106, and data sources 108 may reside on another computing device, provided that each can access and is accessible by each other of management client 104 and management framework 106. In yet other embodiments, one or all of management client 104, management framework 106, data sources 108 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between mobile device 102 and other devices, in accordance with a desired embodiment of the present invention. For example, mobile device 102 communicates with an external source, via network 120, to obtain data for data sources 108.

Management client 104 operates to receive business rules from management framework 106 and display mobile applications on a graphical user interface (GUI) of mobile device 102 in accordance with the business rules. In some embodiments, management client 104 uses the business rules to modify the display or placement of icons, windows, or dialog boxes of an application on the GUI of mobile device 102. In other embodiments, management client 104 uses business rules to provide modification suggestions to the user. In some embodiments, management client 104 installs or deletes an application. In other embodiments, management client 104 modifies a user's access to an application. For example, management client 104 can block user access to a specific application when the phone is handed to a child.

Management framework 106 operates to receive data sources 108, employ self-learning algorithms, determine business rules, and push the business rules to management client 104. Management framework 106 can receive data from multiple data sources 108. Data from data sources 108 is utilized by algorithms to determine application modifications for mobile device 102. The output of each of the algorithms is used to create business rules, which are pushed to management client 104 in order to adjust a GUI. For example, the GUI is adjusted by modifying the display or placement of an icon used to launch an application.

Data sources 108 operate to provide data to management framework 106. Data sources 108 include a user profile, which provides management framework 106 with user history data and user preferences. Data sources 108 include data used to determine application relevancy and display options. For example, data sources 108 can include a global positioning system (GPS) that tracks where mobile device 102 is located. In this example, GPS data indicating an airport as the location of mobile device 102 can be used by the algorithms to create a business rule that causes an application with flight information to be displayed.

Mobile device 102 includes a user interface (UI) 110 which executes locally on mobile device 102 and operates to provide a UI to a user of mobile device 102. UI 110 further operates to receive user input from a user via the provided user interface, thereby enabling the user to interact with mobile device 102. In some embodiments, UI 110 is a GUI. In one embodiment, UI 110 provides a user interface that enables a user of mobile device 102 to interact with management client 104, management framework 106, and data sources 108 of mobile device 102. In various examples, the user interacts with management client 104 in order to utilize a mobile application operating on mobile device 102. In one embodiment, UI 110 is stored on mobile device 102. In other embodiments, UI 110 is stored on another computing device, provided that UI 110 can access and is accessible by at least management client 104.

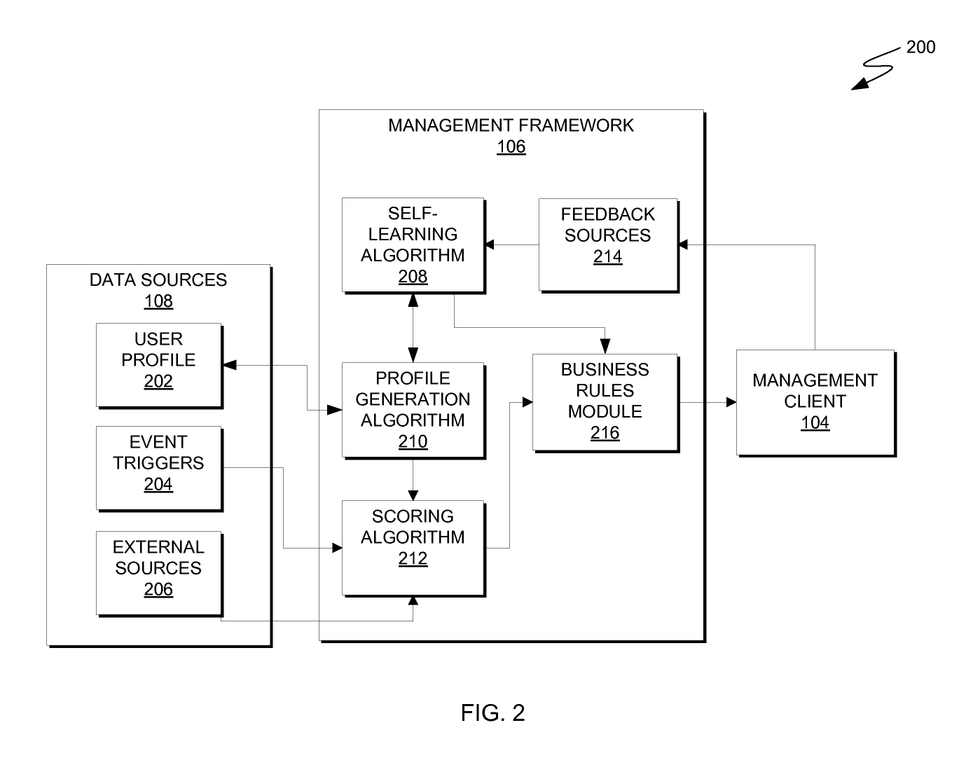

FIG. 2 is a functional block diagram illustrating interactions of components, on a computing device within the computing environment of FIG. 1, in accordance with an embodiment of the present disclosure. For example, FIG. 2 is a block diagram depicting interactions 200 of management client 104, management framework 106, and data sources 108, on mobile device 102 within computing environment 100.

Data sources 108 include data from multiple resources. In some embodiments, data sources 108 are located locally on mobile device 102. In other embodiments, data sources 108 are located externally, on another computing device. For example, data sources 108 can include news events which are received from another computing device via network 120 (FIG. 1). Data sources 108 includes user profile 202, event triggers 204, and external sources 206. In some embodiments, data sources 108 includes other resources not shown in FIG. 2.

User profile 202 contains information about a user of mobile device 102. In some embodiments, where mobile device 102 has multiple users, data sources 108 may contain more than one user profile 202. In some embodiments, a guest user profile is created containing preferences determined by the primary user of mobile device 102. User profile 202 stores dynamic information about the user. For example, user profile 202 stores system preferences, application usage patterns, and environmental surroundings of the user. System preferences include, but are not limited to, network preferences, sound preferences, display preferences, etc. Application usage patterns include, but are not limited to, how frequently an application is used, what other applications are used tangentially to a specific application, how often applications are installed or uninstalled, and how often a specific application is used by the user. Environmental surroundings of a user can include, but are not limited to, GPS data, sounds in the user's environment, data collected from a user's pictures, etc. The data stored in user profile 202 is updated in real time, allowing the algorithms of management framework 106 to account for changes in user behavior.

In some embodiments, data sources 108 includes a separate source for application relevancy network data. This source enables database tracking. For example, the source monitors each time an application is used and for how long. The application relevancy network data also monitors the user location when the application is used, how long the user is at the location, and when the user arrived at the destination (e.g., morning, 10 a.m., etc.). In one embodiment, the data collected by application relevancy network data source is a dynamic pattern. The dynamic pattern allows for dynamic scoring by scoring algorithm 212, based on network graphs.

Data sources 108 includes event triggers 204. Event triggers 204 include emergency news, ambient sound levels, sudden changes in speed of movement, a change in user, or sudden changes in temperature. Event triggers 204 provide data, to algorithms of management framework 106, which affect a user of mobile device 102. For example, event triggers 204 can include the speed at which mobile device 102 is moving. In some embodiments, the speed is used to determine that the user of mobile device 102 is traveling (e.g., driving or on an airplane). In this example, speed data can be used by algorithms of management framework 106 to create a business rule that displays travel related applications on a home screen of a GUI. In some embodiments, event triggers 204 determines that the user of mobile device 102 has changed. In some embodiments, the change is detected by a facial sensor. In other embodiments, the change is detected by a change to the normal user behaviors (e.g., a change in a manner of typing, a change to the speed at which applications are used, etc.). In yet other embodiments, the user change is detected by a user interaction with a prompt on the GUI. In still another embodiment, the user change is detected by pressure sensors on mobile device 102. For example, pressure sensors located on the frame of mobile device 102 detect the grip of a user. In this example, when the grip of the user varies from the grip information stored in user profile 202, the user change is detected. In some embodiments, event triggers 204 data is collected by sensors located within mobile device 102. In other embodiments, event triggers 204 data is collected via communications with other devices.

Data sources 108 includes external sources 206. In some embodiments, external sources 206 includes weather, financial, emergency, or other news. In some embodiments, external sources 206 are collected from other devices via network 120 (FIG. 1). In some embodiments, external sources 206 are collected in real time. For example, emergency news is received by algorithms of management framework 106 in real time. In other embodiments, external sources 206 are collected at set times or intermittently (e.g., every hour). In an embodiment where external sources 206 data is collected intermittently, the time between data collection is configurable by the user via UI 110 (FIG. 1). An example of external source 206 is an emergency weather alert. For example, the emergency weather alert is a tornado warning. In some embodiments, management framework 106 creates a business rule that causes a weather application to display prominently on the phone.

In some embodiments, data sources includes crowd sourcing. The crowd can be, but is not limited to, all users in general, friends and family, coworkers, etc. In some embodiments, crowd sourcing includes social media streams. In some embodiments, crowd sourcing allows management framework 106 to account for how other users interact with an application. In other embodiments, crowd sourcing is used to identify applications that have a similar functionality to the application installed by the user. Crowd sourcing is used by algorithms of management framework 106 to supplement user profile 202, when user profile 202 is missing relevant data.

Management framework 106 comprises multiple algorithms used to create business rules for displaying applications on mobile device 102. Management framework 106 includes feedback sources 214. Feedback sources 214 include user feedback on results of application modifications due to business rules module 216. In some embodiments, feedback sources 214 includes explicit user feedback. For example, in some embodiments, management framework 106 issues a prompt to the user via the GUI of UI 110. In other embodiments, feedback sources 214 includes implicit user feedback. For example, implicit feedback that the user did not need the queued application is provided when a user quickly closes an application opened due to a business rule that queues applications.

Management framework 106 includes self-learning algorithm 208. Self-learning algorithm 208 receives feedback sources 214 to incorporate user feedback into business rules module 216. Self-learning algorithm 208 refines suggestions given to the user based on feedback sources 214. For example, when a user quickly closes an application queued by management framework 106 or ignores a suggestion of management framework 106, self-learning algorithm uses this information for future recommendations. Future recommendations can include queuing different applications, modifying the display of an application, etc. In some embodiments, user feedback is in the form of user action with an application. In other embodiments, user feedback is in the form of user responses to prompts. Self-learning algorithm 208 receives and sends information from/to profile generation algorithm 210.

Management framework 106 includes profile generation algorithm 210. Profile generation algorithm 210 creates and updates user profile 202. Profile generation algorithm 210 monitors user actions on mobile device 102 to generate user profile 202. Profile generation algorithm 210 uses user activity, user feedback, user preferences, etc. to generate a profile for a user of mobile device 102. In some embodiments, profile generation algorithm 210 prompts the user for information via the GUI of UI 110. Profile generation algorithm 210 continues to collect user data to update user profile 202. In some embodiments, profile generation algorithm 210 updates user profile 202 in real time. In other embodiments, profile generation algorithm 210 updates user profile 202 on a set schedule or intermittently (e.g., hourly, daily, etc.).

Management framework 106 includes scoring algorithm 212. Scoring algorithm 212 receives data streams from profile generation algorithm 210 and multiple data sources 108. The data stream from profile generation algorithm 210 includes user feedback from self-learning algorithm 208. Scoring algorithm 212 assigns weights to attributes of various data sources 108. A weight indicates the importance of the data to a user, for example, as determined by scoring algorithm 212. In some embodiments, scoring algorithm 212 receives a feed from a crowd sourcing data source, incorporating social trends into attribute weights. The attribute weights are used, for example, by business rules module 216 to apply business rules.

Management framework 106 includes business rules module 216. Business rules module 216 generates business rules that determine what action to take within management client 104. In some embodiments, business rules module 216 creates a business rule that modifies the appearance of an application on the GUI. For example, business rules module 216 creates a business rule to modify applications to adapt to a child user. In this example, the business rule may be to increase the size of elements on the GUI, to alter the colors, to limit functionality of an application, etc. In some embodiments, business rules module 216 creates a business rule that limits the accessibility of an application. For example, when a new user is detected by event triggers 204, business rules module 216 can create a rule that disables applications that contain user sensitive information (e.g., banking applications). In other embodiments, business rules module 216 creates business rules to install or delete applications from mobile device 102. For example, where crowd sourcing shows a rise in popularity of a new calendaring application, business rules module 216 creates a business rule that recommends the user delete the current calendaring application and install the trending application. In still other embodiments, business rules module 216 creates a rule that queues applications, such that when a user closes a first application, a queued application is automatically opened on the GUI. Business rules module 216 can create other rules that pertain to the display, modification, or management of applications on mobile device 102.

Management client 104 receives the business rules generated by business rules module 216. Management client 104 implements business rules generated by business rules module 216 on mobile device 102. In some embodiments, management client 104 directly modifies an application on mobile device 102. In other embodiments, management client 104 prompts the user for permission to modify an application on mobile device 102. In still other embodiments, management client 104 provides suggestions to modify an application on mobile device 102.

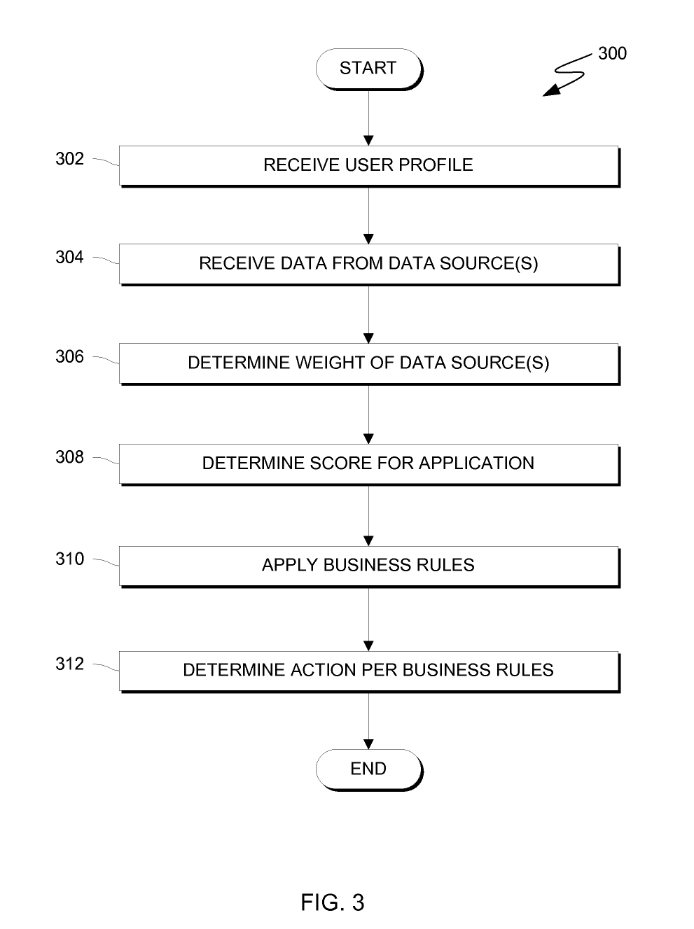

FIG. 3 is a flowchart depicting operations for managing the application framework, on a computing device within the computing environment of FIG. 1, in accordance with an embodiment of the present disclosure. For example, FIG. 3 is a flowchart depicting operations 300 of management framework 106, on mobile device 102 within computing environment 100.

In step 302, management framework 106 receives a user profile. In some embodiments, the user profile is generated using historical user data. For example, historical user data can include commonly used applications, applications used relative in time to another application, time of day when an application is used, duration of an applications use, etc. Historical user data can also include information collected from sensors within mobile device 102. For example, a pressure sensor can be used to collect data on user interaction with a GUI. The pressure sensor data can be used to generate a usage pattern for the user profile. In one example, a usage pattern of a user includes a set of data from a pressure sensor, in which case the set of data is associated with the user. In some embodiments, the usage pattern is used to detect a new user of mobile device 102. The user profile is dynamic and is updated in real time. For example, after the user profile is generated, changes are made to the user profile to account for user feedback, changes in user behavior, etc. via profile generation algorithm 210.

In some embodiments, more than one user profile exists. In these embodiments, management framework 106 receives a user profile based on one or more criteria. In one embodiment, the user profile is received based on sensor readings from mobile device 102. For example, facial recognition or fingerprint data can be used to determine a user. For example, mobile device 102 may include a camera that captures an image of at least a face of the user. In this example, management framework 106 applies at least one facial recognition process using the image and a predetermined facial data of the user, based on which management framework 106 determines that the user of mobile device 102 has changed. In another embodiment, the user profile is received based on user interactions with the GUI. For example, a prompt on the GUI or user typing patterns can be used to identify a user. In some embodiments, the user of mobile device 102 changes during operations 300. In these embodiments, management framework 106 receives the user profile for the new user. For example, after receiving a first user's user profile, the first user hands mobile device 102 to a second user. In response, a new user profile (e.g., a guest profile) is received by management framework 106. Management framework 106 uses the guest profile until a change in user is detected, at which time a different user profile is received by management framework 106.

In step 304, management framework 106 receives data from data sources 108. Data sources 108 includes the user profile, event triggers, external sources, crowd sourcing, etc. Data from data sources 108 is a received by one or more algorithms of management framework 106. For example, data from user profile 202 is received by the profile generation algorithm and data from the event triggers and the external sources is received by the scoring algorithm.

In step 306, management framework 106 determines the weight of data sources. The weight of each attribute of a data sources is determined. The weight is used to determine the impact each data source has on the creation of business rules. In some embodiments, the weights are pre-existing. For example, a user profile has a higher weight than a GPS source. In other embodiments, weights of sources are determined based user habits. For example, some users may have higher weights for social media sources than news sources; whereas, a user who closely follows a news source may have a higher weight for the news sources than social media sources. In some embodiments, the weights of sources can fluctuate over time, based on the user habits. For example, where a user deletes their social media accounts, the weight of social media sources can change. The change in weight allows management framework 106 to modify the impact a data source has on the business rules as circumstances change. In some embodiments, the weight scale is dynamic and is determined by a variety of factors. For example, weights can be influenced by user characteristics (e.g., age, interests, etc.), user preferences, application usage, external factors, user behaviors, etc.

In step 308, management framework 106 determines a score for an application. The weight of each attribute of the data sources is used to determine the score for an application. The application score determine the priority of the application on the GUI. For example, a high weight of a GPS data source causes management framework 106 to determine a score for several travel-related applications. The application score is used to determine business rules with respect to each of the applications.

In step 310, management framework 106 applies business rules. In some embodiments, business rules are predefined or pre-existing. In these embodiments, business rules are updated periodically to better reflect the user's habits. For example, management framework 106 has generic business rules (e.g., display emergency event information). Business rules are added or modified based on the algorithms of management framework 106. For example, a business rule to open an email application at a specific time of day (e.g., 9 am) is added when a user consistently opens the email application at the same time every day.

Business rules are used to determine customization of applications on mobile device 102. Business rules are applied using the weights of data sources and scores of applications. Business rule can vary based on the user profile, data sources, and applications on mobile device 102. In one embodiment, business rules may be to suggest a change the user of mobile device 102. In another embodiment, the business rules can alter an applications presentation on a GUI. In another embodiment, a business rule can restrict a user's access to an application. In another embodiment, a business rule can suggest that an application be installed or uninstalled. In yet another embodiment, a business rule can queue one or more applications. Each business rule enables management framework 106 to modify or suggest a change to an application on mobile device 102.

In step 312, management framework 106 determines action per business rules. Actions determined by management framework 106 are implemented by management client 104 of mobile device 102. For example, where a business rule is to suggest a change, the action can be to display a prompt on the GUI. In one embodiment, the display of an application in the GUI is modified. For example, business rules are used to increase the text size of flight information for a user using a travel application in an airport. In another example, the home screen of the mobile device is modified to show relevant application icons. In another embodiment, applications are hidden, such that certain users cannot access the application. For example, where a new user is detected, banking applications are hidden. Hiding applications allows sensitive user information to be hidden when a guest user uses the mobile device. In some embodiments, business rules indicate installing or uninstalling an application. For example, the action can be to prompt the user to install a new application.

FIG. 4 is a block diagram of components of a computing device, generally designated 400, in accordance with an embodiment of the present disclosure. In one embodiment, computing device 400 is representative of mobile device 102. For example, FIG. 4 is a block diagram of mobile device 102 within computing environment 100 executing operations of management framework 106.

It should be appreciated that FIG. 4 provides only an illustration of one implementation and does not imply any limitations with regard to the environments in which different embodiments may be implemented. Many modifications to the depicted environment may be made.

Computing device 400 includes communications fabric 408, which provides communications between computer processor(s) 402, memory 404, cache 406, persistent storage 410, communications unit 414, and input/output (I/O) interface(s) 412. Communications fabric 408 can be implemented with any architecture designed for passing data and/or control information between processors (such as microprocessors, communications and network processors, etc.), system memory, peripheral devices, and any other hardware components within a system. For example, communications fabric 408 can be implemented with one or more buses.

Memory 404 and persistent storage 410 are computer-readable storage media. In this embodiment, memory 404 includes random access memory (RAM). In general, memory 404 can include any suitable volatile or non-volatile computer readable storage media. Cache 406 is a fast memory that enhances the performance of processors 402 by holding recently accessed data, and data near recently accessed data, from memory 404.

Program instructions and data used to practice embodiments of the present invention may be stored in persistent storage 410 and in memory 404 for execution by one or more of the respective processors 402 via cache 406. In an embodiment, persistent storage 410 includes a magnetic hard disk drive. Alternatively, or in addition to a magnetic hard disk drive, persistent storage 410 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 410 may also be removable. For example, a removable hard drive may be used for persistent storage 410. Other examples include optical and magnetic disks, thumb drives, and smart cards that are inserted into a drive for transfer onto another computer-readable storage medium that is also part of persistent storage 410.

Communications unit 414, in these examples, provides for communications with other data processing systems or devices, including resources of network 120. In these examples, communications unit 414 includes one or more network interface cards. Communications unit 414 may provide communications through the use of either or both physical and wireless communications links. Program instructions and data used to practice embodiments of the present invention may be downloaded to persistent storage 410 through communications unit 414.

I/O interface(s) 412 allows for input and output of data with other devices that may be connected to computing device 400. For example, I/O interface 412 may provide a connection to external devices 416 such as a keyboard, keypad, a touch screen, and/or some other suitable input device. External devices 416 can also include portable computer-readable storage media such as, for example, thumb drives, portable optical or magnetic disks, and memory cards. Software and data used to practice embodiments of the present invention (e.g., software and data) can be stored on such portable computer-readable storage media and can be loaded onto persistent storage 410 via I/O interface(s) 412. I/O interface(s) 412 also connect to a display 418.

Display 418 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
receiving, by one or more processors, a user profile, wherein the user profile corresponds to a first user of a mobile device;
receiving, by or more processors, data corresponding to an application, wherein the application is compatible with the mobile device;
determining, by one or more processors, that the application is likely to be accessed by the first user based on, at least, the data corresponding to the application; and
adjusting, by one or more processors, at least one aspect of the application on a user interface of the mobile device.

2. The method of claim 1, wherein determining that the application is likely to be accessed by the first user comprises:
determining, by one or more processors, a weight for the data corresponding to the application, wherein the weight indicates importance of the data based on preferences of the first user;
determining, by one or more processors, a score for the application based, at least in part, on the weight for the data corresponding to the application; and
identifying, by one or more processors, the at least one aspect of the application to adjust based on, at least, the score for the application.

3. The method of claim 1, further comprising:
identifying, by one or more processors, a second user of the mobile device, wherein the second user is different than the first user; and
in response to identifying the second user, adjusting, by one or more processors, the user interface of the mobile device, based on a set of predefined rules of the first user.

4. The method of claim 3, wherein identifying the second user of the mobile device comprises:
receiving, by one or more processors, a first set of data from a pressure sensor on the mobile device;
comparing, by one or more processors, the first set of data from the pressure sensor to a previously stored second set of data from the pressure sensor associated with the first user; and
identifying, by one or more processors, the second user of the mobile device based on, at least, the comparison of the first set of data from the pressure sensor to the previously stored second set of data from the pressure sensor.

5. The method of claim 3, wherein identifying the second user of the mobile device comprises:
receiving, by one or more processors, an image from a camera on the mobile device, wherein the image includes a face;
performing, by one or more processors, a facial recognition process on the face of the image; and
identifying, by one or more processors, the second user of the mobile device based on, results of the facial recognition process.

6. The method of claim 1, wherein the at least one aspect of the application to adjust comprises installing the application on the mobile device.

7. The method of claim 1, wherein adjusting the at least one aspect of the application on the user interface of the mobile device comprises adjusting an aspect of an icon to access the application.

8. A computer program product, the computer program product comprising:
a computer readable storage medium and program instructions stored on the computer readable storage medium, the program instructions comprising:
program instructions to receive a user profile, wherein the user profile corresponds to a first user of a mobile device;
program instructions to receive data corresponding to an application, wherein the application is compatible with the mobile device;
program instructions to determine that the application is likely to be accessed by the first user based on, at least, the data corresponding to the application; and
program instructions to adjust at least one aspect of the application on a user interface of the mobile device.

9. The computer program product of claim 8, wherein program instructions to determine that the application is likely to be accessed by the first user comprises:
program instructions to determine a weight for the data corresponding to the application, wherein the weight indicates importance of the data based on preferences of the first user;
program instructions to determine a score for the application based, at least in part, on the weight for the data corresponding to the application; and
program instructions to identify the at least one aspect of the application to adjust based on, at least, the score for the application.

10. The computer program product of claim 8, further comprising:
program instructions to identify a second user of the mobile device, wherein the second user is different than the first user; and
program instructions to adjust the user interface of the mobile device in response to identifying the second user and based on a set of predefined rules of the first user.

11. The computer program product of claim 10, wherein program instructions to identify the second user of the mobile device comprises:
program instructions to receive a first set of data from a pressure sensor on the mobile device;
program instructions to compare the first set of data from the pressure sensor to a previously stored second set of data from the pressure sensor associated with the first user; and
program instructions to identify the second user of the mobile device based on, at least, the comparison of the first set of data from the pressure sensor to the previously stored second set of data from the pressure sensor.

12. The computer program product of claim 10, wherein program instructions to identify the second user of the mobile device comprises:
program instructions to receive an image from a camera on the mobile device, wherein the image includes a face;
program instructions to perform a facial recognition process on the face of the image; and
program instructions to identify the second user of the mobile device based on, results of the facial recognition process.

13. The computer program product of claim 8, wherein the at least one aspect of the application to adjust comprises program instructions to install the application on the mobile device.

14. The computer program product of claim 8, wherein program instructions to adjust the at least one aspect of the application on the user interface of the mobile device comprises program instructions to adjust an aspect of an icon to access the application.

15. A computer system, the computer system comprising:
one or more computer processors;
one or more computer readable storage media;
program instructions stored on the computer readable storage media for execution by at least one of the one or more processors, the program instructions comprising:
program instructions to receive a user profile, wherein the user profile corresponds to a first user of a mobile device;
program instructions to receive data corresponding to an application, wherein the application is compatible with the mobile device;
program instructions to determine that the application is likely to be accessed by the first user based on, at least, the data corresponding to the application; and
program instructions to adjust at least one aspect of the application on a user interface of the mobile device.

16. The computer system of claim 15, wherein program instructions to determine that the application is likely to be accessed by the first user comprises:
program instructions to determine a weight for the data corresponding to the application, wherein the weight indicates importance of the data based on preferences of the first user;
program instructions to determine a score for the application based, at least in part, on the weight for the data corresponding to the application; and
program instructions to identify the at least one aspect of the application to adjust based on, at least, the score for the application.

17. The computer system of claim 15, further comprising:
program instructions to identify a second user of the mobile device, wherein the second user is different than the first user; and
program instructions to adjust the user interface of the mobile device in response to identifying the second user and based on a set of predefined rules of the first user.

18. The computer system of claim 17, wherein program instructions to identify the second user of the mobile device comprises:
program instructions to receive a first set of data from a pressure sensor on the mobile device;
program instructions to compare the first set of data from the pressure sensor to a previously stored second set of data from the pressure sensor associated with the first user; and
program instructions to identify the second user of the mobile device based on, at least, the comparison of the first set of data from the pressure sensor to the previously stored second set of data from the pressure sensor.

19. The computer system of claim 17, wherein program instructions to identify the second user of the mobile device comprises:
program instructions to receive an image from a camera on the mobile device, wherein the image includes a face;
program instructions to perform a facial recognition process on the face of the image; and
program instructions to identify the second user of the mobile device based on, results of the facial recognition process.

20. The computer system of claim 15, wherein program instructions to adjust the at least one aspect of the application on the user interface of the mobile device comprises program instructions to adjust an aspect of an icon to access the application.
